(19) United States
(12) Patent Application Publication
(10) Pub. No.: US 2020/0306722 A1
(43) Pub. Date: Oct. 1, 2020

(54) PHOSPHORUS ADSORBENT AND METHOD OF PRODUCING PHOSPHORUS ADSORBENT

(71) Applicant: Fujita Corporation, Tokyo (JP)

(72) Inventors: Shota FUKURO, Tokyo (JP); Nobuyuki KITAJIMA, Tokyo (JP)

(21) Appl. No.: 16/902,421

(22) Filed: Jun. 16, 2020

Related U.S. Application Data
(63) Continuation of application No. PCT/JP2018/047074, filed on Dec. 20, 2018.

(30) Foreign Application Priority Data
Dec. 20, 2017 (JP) 2017-244042

(51) Int. Cl. B01J 20/02; B01J 20/20; B01J 20/30

(52) U.S. Cl. CPC B01J 20/0229; B01J 20/3078; B01J 20/20

(57) ABSTRACT

A phosphorus adsorbent includes a carrier that is a carbonized organic substance and iron supported on the carrier. A method of producing the phosphorus adsorbent includes immersing an organic substance in a chemical solution containing iron ions and carbonizing the organic substance after the immersion.

### CROSS-REFERENCE TO RELATED APPLICATIONS

This application is a continuation of International Application No. PCT/JP2018/047074, filed on Dec. 20, 2018, which claims priority to Japanese Application No. 2017-244042, filed on Dec. 20, 2017. The contents of these applications are incorporated herein by reference in their entirety.

### BACKGROUND

### 1. Technical Field

The present invention relates to a phosphorus adsorbent and a method of producing the phosphorus adsorbent.

### 2. Description of the Related Art

In order to reduce the amount of carbon dioxide in the atmosphere, techniques for artificially recovering carbon dioxide and storing the carbon dioxide in the ground have been known. For example, carbon is stored in the ground by burying carbonized biomass in farmland or the like. Burying carbon-containing biomass in the ground means burying plants that have absorbed carbon dioxide in the atmosphere in the ground, which leads to reduction in the amount of carbon dioxide in the atmosphere. However, although carbides have the effect of improving soil, the carbides do not have a large effect on crop yields. Therefore, an increase in the demand for the carbides is limited. On the other hand, a large amount of fertilizer is continuously supplied to farmland to improve crop yields.

Meanwhile, in a technical field different from the technical field described above, water pollution due to discharging phosphorus to a natural water area has caused a problem. For this reason, various techniques for removing phosphorus have been known. For example, Japanese Laid-open Patent Publication No. 2007-75706 (JP-A-2007-75706) describes a phosphorus recovery material composed of carbonized rice husk supporting calcium. Burying the phosphorus recovery material described in JP-A-2007-75706 in farmland causes elution of phosphorus in the soil. The phosphorus recovery material described in JP-A-2007-75706 can be used as a fertilizer and thus the demanded amount of the carbides may be increased.

However, for the phosphorus recovery material ofJP-A-2007-75706, a material including a large amount of silicon such as rice husk or diatomaceous earth needs to be used. Use of the material including a large amount of silicon results in difficulty in significant increase in the amount of carbon that can be stored in the ground due to limitation of the amount of phosphorus recovery material that can be produced.

The present disclosure has been made in view of the above problem, and aims to provide a phosphorus adsorbent that can be produced from various materials and a method of producing the phosphorus adsorbent that can be produced from various materials.

### SUMMARY

In order to achieve the above-mentioned purpose, a phosphorus adsorbent according to an aspect of the present disclosure includes a carrier that is a carbonized organic substance, and iron supported on the carrier.

In one aspect of the phosphorus adsorbent, peaks corresponding to iron are present in a measurement result of an X-ray diffraction method.

In one aspect of the phosphorus adsorbent, intensity of a maximum peak corresponding to iron is equal to or more than one-half of intensity of a maximum peak corresponding to magnetite in the measurement result of the X-ray diffraction method.

In one aspect of the phosphorus adsorbent, the carrier is porous, and part of the iron is located inside the carrier.

A method of producing a phosphorus adsorbent according to another aspect of the present disclosure, the method includes immersing an organic substance in a chemical solution containing iron ions, and carbonizing the organic substance after the immersion.

In one aspect of the method of producing a phosphorus adsorbent, the chemical solution is an iron chloride aqueous solution, and a maximum temperature of the organic substance at the carbonization is 700° C. or more.

In one aspect of the method of producing a phosphorus adsorbent, the maximum temperature of the organic substance at the carbonization is 900° C. or less.

In one aspect of the method of producing a phosphorus adsorbent, a mass percent concentration of iron in the chemical solution is 4% or more.

In one aspect of the method of producing a phosphorus adsorbent, at the immersion, time for immersing the organic substance in the chemical solution is 30 minutes or more.

In one aspect of the method of producing a phosphorus adsorbent, the organic substance is wood.

In one aspect of the method of producing a phosphorus adsorbent, the chemical solution is a ferric chloride aqueous solution, the organic substance is dried wood, and

a maximum temperature of the organic substance at the carbonization is 800° C. or more.

In one aspect of the method of producing a phosphorus adsorbent, the chemical solution is a ferric chloride aqueous solution; the organic substance is raw wood; and

a maximum temperature of the organic substance at the carbonization is 700° C. or more and 900° C. or less.

In one aspect of the method of producing a phosphorus adsorbent, the maximum temperature of the organic substance at the carbonization is 750° C. or less.

In one aspect of the method of producing a phosphorus adsorbent, the chemical solution is a ferrous chloride aqueous solution, the organic substance is dried wood, and

a maximum temperature of the organic substance at the carbonization is 700° C. or more.

In one aspect of the method of producing a phosphorus adsorbent, the chemical solution is a ferrous chloride aqueous solution, the organic substance is raw wood, and

a maximum temperature of the organic substance at the carbonization is 800° C. or more.

In one aspect of the method of producing a phosphorus adsorbent, the maximum temperature of the organic substance at the carbonization is 900° C. or less.

### Advantageous Effects of Invention

According to the present disclosure, a phosphorus adsorbent that can be produced from various materials and a method of producing the phosphorus adsorbent that can be produced from various materials can be provided.

### BRIEF DESCRIPTION OF THE DRAWINGS

FIG. 1 is a schematic view of a phosphorus adsorbent according to an embodiment.

FIG. 2 is a flow chart illustrating a method of producing the phosphorus adsorbent according to the embodiment.

FIG. 3 is a graph illustrating the electrical conductivity and pH of a test liquid, in the case where the sequence of an immersion and a carbonization step and the combination of the solutes at the immersion step are changed.

FIG. 4 is a graph illustrating the electrical conductivity, phosphorus removal ratio, and pH of the test liquid, in the case where the combination of materials, the solutes of the chemical solution in the immersion step, and the temperatures at the carbonization step are changed.

FIG. 5 is a graph illustrating the electrical conductivity, phosphorus removal ratio, and pH of the test liquid, in the case where the combination of materials, the solutes of the chemical solution in the immersion step, and the temperatures at the carbonization step are changed.

FIG. 6 is a graph illustrating the electrical conductivity and the phosphorus removal ratio of the test liquid in the case where immersion time at the immersion step is changed.

FIG. 7 is a graph illustrating changes in the electrical conductivity and the phosphorus removal ratio of the test liquid when the aqueous solution concentration at the immersion step is changed.

FIG. 8 is a graph illustrating the measurement results of an X-ray diffraction method with respect to a sample that is not carbonized after immersing raw wood in a ferric chloride aqueous solution.

FIG. 9 is a graph illustrating the measurement results of the X-ray diffraction method with respect to a sample that is produced by immersing raw wood in the ferric chloride aqueous solution and thereafter carbonizing the immersed wood at 600° C.

FIG. 10 is a graph illustrating the measurement results of the X-ray diffraction method with respect to a sample that is produced by immersing dried wood in a ferrous chloride aqueous solution and thereafter carbonizing the immersed wood at 600° C.

FIG. 11 is a graph illustrating the measurement results of the X-ray diffraction method with respect to a sample that is produced by immersing raw wood in the ferric chloride aqueous solution and thereafter carbonizing the immersed wood at 650° C.

FIG. 12 is a graph illustrating the measurement results of the X-ray diffraction method with respect to a sample that is produced by immersing dried wood in the ferric chloride aqueous solution and thereafter carbonizing the immersed wood at 700° C.

FIG. 13 is a graph illustrating the measurement results of the X-ray diffraction method with respect to a sample that is produced by immersing dried wood in a polyferric sulfate aqueous solution and thereafter carbonizing the immersed wood at 700° C.

FIG. 14 is a graph illustrating the measurement results of the X-ray diffraction method with respect to a sample that is produced by immersing dried wood in the ferric nitrate aqueous solution and thereafter carbonizing the immersed wood at 700° C.

FIG. 15 is a graph illustrating the measurement results of the X-ray diffraction method with respect to a sample that is produced by immersing raw wood in the ferric chloride aqueous solution and thereafter carbonizing the immersed wood at 700° C.

FIG. 16 is a graph illustrating the measurement results of the X-ray diffraction method with respect to a sample that is produced by immersing raw wood in the ferrous chloride aqueous solution and thereafter carbonizing the immersed wood at 700° C.

FIG. 17 is a graph illustrating the measurement results of the X-ray diffraction method with respect to a sample that is produced by immersing dried wood in the ferrous chloride aqueous solution and thereafter carbonizing the immersed wood at 700° C.

FIG. 18 is a graph illustrating the measurement results of the X-ray diffraction method with respect to a sample that is produced by immersing raw wood in the ferric chloride aqueous solution and thereafter carbonizing the immersed wood at 800° C.

FIG. 19 is a graph illustrating the measurement results of the X-ray diffraction method with respect to a sample that is produced by immersing dried wood in the ferrous chloride aqueous solution and thereafter carbonizing the immersed wood at 800° C.

FIG. 20 is a graph illustrating the measurement results of the X-ray diffraction method with respect to a sample that is produced by immersing raw wood in the ferric chloride aqueous solution and thereafter carbonizing the immersed wood at 900° C.

### DETAILED DESCRIPTION

The present invention is described in detail below with reference to the drawings. The present invention is not limited to modes (hereinafter referred to as embodiments) for carrying out the present invention. Constituents in the following embodiments include a constituent that is easily conceivable by those skilled in the art, a constituent that is substantially identical thereto, and a constituent within a so-called range of equivalents. Furthermore, the constituents disclosed in the following embodiments can be combined as appropriate.

### Embodiment

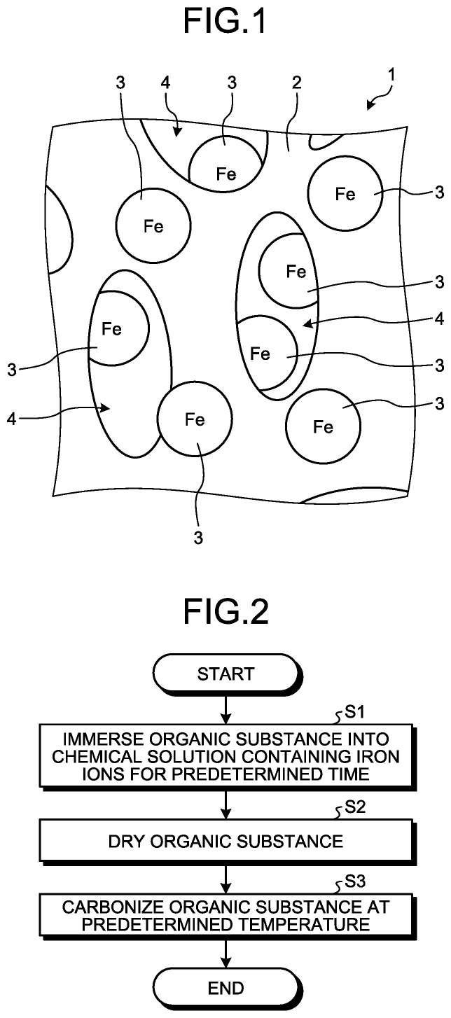

FIG. 1 is a schematic view of the phosphorus adsorbent according to the embodiment. As illustrated in FIG. 1, the phosphorus adsorbent 1 according to the embodiment includes a carrier 2 and iron (Fe) 3. The carrier 2 is a carbonized organic substance. The carbonization means that an organic compound is decomposed by a chemical change, so that the carbon content in the organic compound becomes a major part. For example, heating a material mainly composed of carbon compounds such as wood causes combustion and thus carbon combines with surrounding oxygen to form gaseous carbon dioxide. In the case where heating is carried out in a state of shielding oxygen, decomposition of the carbon compound occurs and a relatively large amount of solid carbon having a low volatility remains from the decomposed carbon compound. This phenomenon is referred to as carbonization. One example of the carrier 2 is carbonized biomass. For example, the carrier 2 in the embodiment is carbonized wood. The carrier 2 is porous and includes a plurality of pores 4. The iron 3 is supported by the carrier 2. The iron 3 is attached to the outer surface of the carrier 2 and the inner surface of the carrier 2. Namely, part of the iron 3 is located outside the carrier 2 and part of the iron 3 is located inside (hole 4) the carrier 2. In the present disclosure, the iron 3 is iron (Fe) existing as a metal, and does not include a compound of iron (for example, iron chloride, iron nitrate, and iron oxide (such as magnetite (triiron tetraoxide) and hematite (diiron trioxide))).

The organic substance used as the carrier 2 is not necessarily wood. Other examples of the organic substance used as the carrier 2 include agricultural products and food wastes. The carrier is not necessarily porous.

FIG. 2 is a flow chart illustrating a method of producing the phosphorus adsorbent according to the embodiment. As illustrated in FIG. 2, the method of producing the phosphorus adsorbent 1 includes an immersion step S1, a drying step S2, and a carbonization step S3.

At the immersion step S1, the organic substance is immersed in a chemical solution containing iron ions for a predetermined time. Examples of chemical solutions containing iron ions include a ferrous chloride (FeCl₂) aqueous solution, a ferric chloride (FeCl₃) aqueous solution, a ferric nitrate (Fe(NO₃)₃) aqueous solution, a ferrous sulfate (FeSO₄) aqueous solution, and a polyferric sulfate (Fe₂(SO₄)₃) aqueous solution. The chemical solution is preferably an iron chloride aqueous solution. The predetermined time for immersing the organic substance in the chemical solution is not particularly limited and is preferably 30 minutes or more. The predetermined time is more preferably 1 hour or more and further preferably 2 hours or more. The mass percent concentration of iron included in the chemical solution is preferably 4% or more.

The organic substance immersed in a chemical solution at the immersion step S1 is, for example, wood. The wood may be dried wood or raw wood. The water content of the raw wood is about 30% or more and about 70% or less. The water content is a value obtained by dividing the mass of water included in the organic substance by the mass of the organic substance and multiplying the divided value by 100. The organic substance to be immersed in the chemical solution may be the agricultural products. The agricultural products may be dried agricultural products or raw agricultural products. The water content of the raw agricultural products is about 60% or more and about 95% or less.

After the immersion step S1, the organic substance is dried at the drying step S2.

After the drying step S2, the organic substance is carbonized at a predetermined temperature at the carbonization step S3. The predetermined temperature is preferably 700° C. or more and 900° C. or less. At the carbonization step S3, the organic substance is carbonized, for example, in a furnace shielding air (oxygen). Here, at carbonization step S3, the organic substance may be carbonized in the furnace into which inert gas (nitrogen gas or the like) is supplied. The inert gas reduces the oxygen in the furnace. For example, in the case where the chemical solution at the immersion step S1 is an aqueous solution of a compound containing oxygen molecules (for example, a ferric nitrate aqueous solution, a ferrous sulfate aqueous solution, and a polyferric sulfate aqueous solution), an inert gas may be used. Further, at the carbonization step S3, for example, the organic substance may be carbonized in a heat-resistant container (a crucible) sealed with a lid.

Several experiments have been carried out for the phosphorus adsorbent. The experimental results will be described below.

(First Experiment)

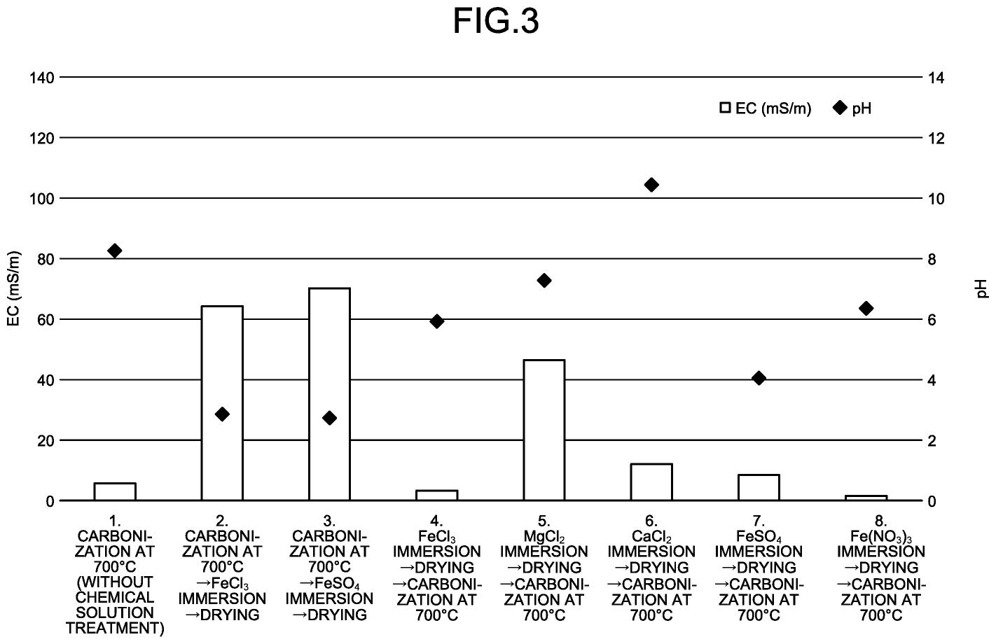

FIG. 3 is a graph illustrating the electrical conductivity and pH of a test liquid, in the case where the sequence of the immersion step and the carbonization step and the combination of the solutes at the immersion step are changed. FIG. 3 illustrates the results of the first experiment. In the first experiment, the test container containing the phosphorus adsorbent and the test liquid was stirred by a shaker for 6 hours, and thereafter the EC (electrical conductivity) and pH of the filtrate of the test liquid were measured.

The amount of each sample (phosphorus adsorbent) in the first experiment is 0.5 g. The test liquid is a potassium dihydrogen phosphate aqueous solution. The concentration of phosphorus in the test liquid is 2 mg/l. The amount of test liquid is 100 ml. The EC of the test liquid is 0.9 mS/m. The pH of the test liquid is 5.512. The test container is a polypropylene bottle with a lid. The volume of the test container is 250 ml.

The material of the sample (phosphorus adsorbent) in the first experiment is dried waste wood chips. In FIG. 3, the first sample to eighth sample are arranged from the left to the right of the horizontal axis. The first sample in the first experiment was produced by carbonizing the material at 700° C. without being immersed in the chemical solution. The second sample was produced by carbonizing the material at 700° C., thereafter immersing the material in a ferric chloride aqueous solution for 24 hours, and thereafter drying the material. The third sample was produced by carbonizing the material at 700° C., thereafter immersing the material in a ferrous sulfate aqueous solution for 24 hours, and thereafter drying the material. The fourth sample was produced by immersing the material in the ferric chloride aqueous solution for 24 hours, thereafter drying the material, and then carbonizing the material at 700° C. The fifth sample was produced by immersing the material in a magnesium chloride (MgCl₂) aqueous solution for 24 hours, thereafter drying the material, and then carbonizing the material at 700° C. The sixth sample was produced by immersing the material in a calcium chloride (CaCl₂)) aqueous solution for 24 hours, thereafter drying the material, and then carbonizing the material at 700° C. The seventh sample was produced by immersing the material in the ferrous sulfate aqueous solution for 24 hours, thereafter drying the material, and then carbonizing the material at 700° C. The eighth sample was produced by immersing the material in the ferric nitrate aqueous solution for 24 hours, thereafter drying the material, and then carbonizing the material at 700° C. The carbonization was carried out in an air (oxygen) shielded crucible without inert gas. Similarly, in the other experiments described below, the carbonization was carried out in the air (oxygen) shielded crucible without inert gas.

In the ferric chloride aqueous solution, the mass percent concentration of iron chloride hexahydrate (FeCl₃.6H₂O) is 20%. In the ferrous sulfate aqueous solution, the mass percent concentration of iron sulfide heptahydrate (FeSO₄.7H₂O) is 20%. In the magnesium chloride aqueous solution, the mass percent concentration of magnesium chloride hexahydrate (MgCl₂.6H₂O) is 20%. In the calcium chloride aqueous solution, the mass percent concentration of calcium chloride dihydrate (CaCl₂.2H₂O) is 20%. In the ferric nitrate aqueous solution, the mass percent concentration of ferric nitrate nonahydrate (Fe(NO₃)₃.9H₂O) is 20%.

As illustrated in FIG. 3, in the experiment of the samples (the second sample and the third sample) immersed in the chemical solution containing iron ions after the carbonization, the EC of the test liquid was high and the test liquid was acidic. The reason why the EC of the test liquid is high is considered to be elution of the metal included in the sample into the test liquid. Namely, low EC means that the metal included in the sample is difficult to elute into the test liquid. The low EC is preferable for the phosphorus adsorbent. This is because, in the case where the phosphorus adsorbent is actually used, a low concentration phosphorus aqueous solution is allowed to flow for a long period of time through a tank or a column (cylindrical member) filled with the phosphorus adsorbent. In the case of high EC, the metal included in the phosphorus adsorbent flows out immediately after the start of water flow to a tank or a column. Therefore, a sample with the high EC is not suitable for use as the phosphorus adsorbent. On the other hand, in the experiment of the samples (the fourth sample, the seventh sample, and the eighth sample) carbonized after being immersed in the chemical solution containing iron ions, the EC of the test liquid is low and the test liquid is neutral or acidic. In the experiment of the fifth sample using the magnesium chloride aqueous solution, the EC of the test liquid was high and the test liquid was alkaline. In the experiment of the sixth sample using the calcium chloride aqueous solution, the EC of the test liquid was low and the test liquid was alkaline.

In the fifth sample and sixth sample, the pH of the test liquid is higher than the pH (5.512) of the test liquid before the experiment. Therefore, the fifth sample and sixth sample are not suitable for use. The second sample, the third sample, and the fifth sample are not suitable for use in that the metal is easily eluted (EC is high). In the second sample, the third sample, the fifth sample, and the sixth sample, iron (Fe) as a metal is not supported on the carrier. On the other hand, samples (the fourth sample, the seventh sample, and the eighth sample) carbonized after being immersed in the chemical solution containing iron ions are suitable for use in that the metal is less likely to be eluted (EC is lower). Therefore, the phosphorus adsorbent is preferably produced by the above-described production method including the carbonization step S3 after the immersion step S1.

(Second Experiment)

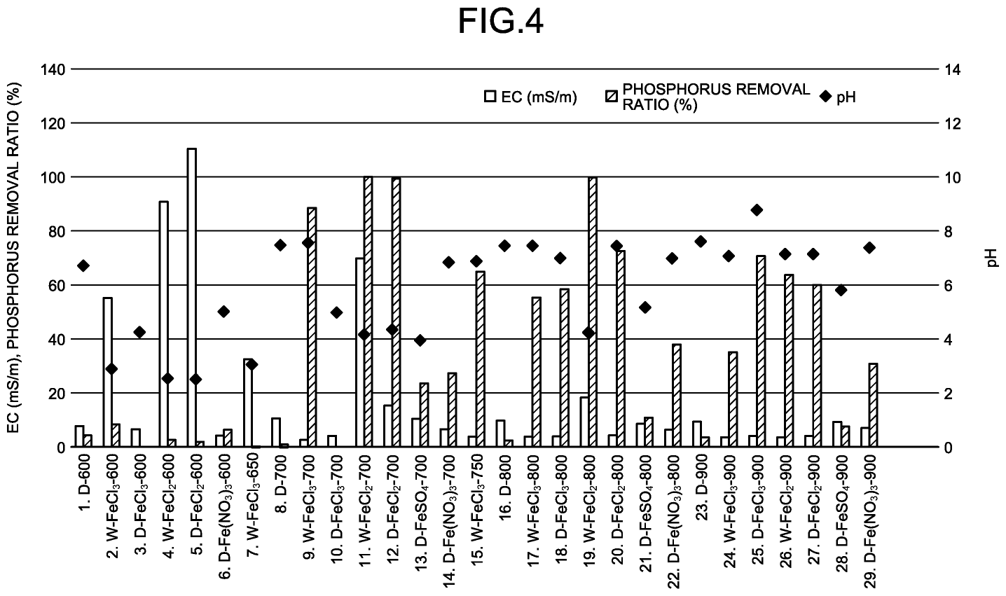

FIG. 4 is a graph illustrating the electrical conductivity, phosphorus removal ratio, and pH of the test liquid, in the case where the combination of materials, the solutes of the chemical solution in the immersion step, and temperatures at the carbonization step are changed. FIG. 4 illustrates the result of the second experiment. In the second experiment, the test container containing the phosphorus adsorbent and the test liquid was stirred by a shaker for 6 hours, and thereafter the EC, the pH, and the phosphorus removal ratio of the filtrate of the test liquid were measured.

The amount of each sample (phosphorus adsorbent) in the second experiment is 0.5 g. The test liquid is a potassium dihydrogen phosphate aqueous solution. The concentration of phosphorus in the test liquid is 10 mg/l. The amount of test liquid is 50 ml. The EC of the test liquid is 3.45 mS/m. The pH of the test liquid is 5.26. The test container is a polypropylene bottle with a lid. The volume of the test container is 100 ml.

The material of the sample (phosphorus adsorbent) in the second experiment is red pine chips. As the samples in the second experiment, dried red pine chips or red pine chips made of raw wood were used. D illustrated on the horizontal axis of FIG. 4 means that the dried red pine chips were used. W illustrated on the horizontal axis of FIG. 4 means that the red pine chips made of raw wood were used. In FIG. 4, the first sample to twenty-ninth sample are arranged from the left to the right of the horizontal axis.

Except part of the samples, the samples in the second experiment were produced by carbonizing the samples at predetermined temperatures after immersing the samples in the chemical solutions. Part of the samples (the first sample, the eighth sample, the sixteenth sample, and the twenty-third sample) were carbonized at predetermined temperatures without being immersed in the chemical solution. The first sample was carbonized at 600° C. The eighth sample was carbonized at 700° C. The sixteenth sample was carbonized at 800° C. The twenty-third sample was carbonized at 900° C.

The second sample in the second experiment was produced by immersing the red pine chips made of raw wood in the ferric chloride aqueous solution for 24 hours, thereafter drying the chips, and then carbonizing the chips at 600° C. The third sample was produced by immersing the dried red pine chips in the ferric chloride aqueous solution for 24 hours, thereafter drying the chips, and then carbonizing the chips at 600° C. The fourth sample was produced by immersing the red pine chips made of raw wood in the ferrous chloride aqueous solution for 24 hours, thereafter drying the chips, and then carbonizing the chips at 600° C. The fifth sample was produced by immersing the dried red pine chips in the ferrous chloride aqueous solution for 24 hours, thereafter drying the chips, and then carbonizing the chips at 600° C. The sixth sample was produced by immersing the dried red pine chips in the ferric nitrate aqueous solution for 24 hours, thereafter drying the chips, and then carbonizing the chips at 600° C. The seventh sample was produced by immersing the red pine chips made of raw wood in the ferric chloride aqueous solution for 24 hours, thereafter drying the chips, and then carbonizing the chips at 650° C.

The ninth sample was produced by immersing the red pine chips made of raw wood in the ferric chloride aqueous solution for 24 hours, thereafter drying the chips, and then carbonizing the chips at 700° C. The tenth sample was produced by immersing the dried red pine chips in the ferric chloride aqueous solution for 24 hours, thereafter drying the chips, and then carbonizing the chips at 700° C. The eleventh sample was produced by immersing the red pine chips made of raw wood in the ferrous chloride aqueous solution for 24 hours, thereafter drying the chips, and then carbonizing the chips at 700° C. The twelfth sample was produced by immersing the dried red pine chips in the ferrous chloride aqueous solution for 24 hours, thereafter drying the chips, and then carbonizing the chips at 700° C. The thirteenth sample was produced by immersing the dried red pine chips in the ferrous sulfate aqueous solution for 24 hours, thereafter drying the chips, and then carbonizing the chips at 700° C. The fourteenth sample was produced by immersing the dried red pine chips in the ferric nitrate aqueous solution for 24 hours, thereafter drying the chips, and then carbonizing the chips at 700° C. The fifteenth sample was produced by immersing the red pine chips made of raw wood in the ferric chloride aqueous solution for 24 hours, thereafter drying the chips, and then carbonizing the chips at 750° C.

The seventeenth sample was produced by immersing the red pine chips made of raw wood in the ferric chloride aqueous solution for 24 hours, thereafter drying the chips, and then carbonizing the chips at 800° C. The eighteenth sample was produced by immersing the dried red pine chips in the ferric chloride aqueous solution for 24 hours, thereafter drying the chips, and carbonizing the chips at 800° C. The nineteenth sample was produced by immersing the red pine chips made of raw wood in the ferrous chloride aqueous solution for 24 hours, thereafter drying the chips, and then carbonizing the immersed wood at 800° C. The twentieth sample was produced by immersing the dried red pine chips in the ferrous chloride aqueous solution for 24 hours, thereafter drying the chips, and then carbonizing the chips at 800° C. The twenty-first sample was produced by immersing the dried red pine chips in the ferrous sulfate aqueous solution for 24 hours, thereafter drying the chips, and then carbonizing the chips at 800° C. The twenty-second sample was produced by immersing the dried red pine chips in the ferric nitrate aqueous solution for 24 hours, thereafter drying the chips, and then carbonizing the chips at 800° C.

The twenty-fourth sample was produced by immersing the red pine chips made of raw wood in the ferric chloride aqueous solution for 24 hours, thereafter drying the chips, and then carbonizing the chips at 900° C. The twenty-fifth sample was produced by immersing the dried red pine chips in the ferric chloride aqueous solution for 24 hours, thereafter drying the chips, and then carbonizing the chips at 900° C. The twenty-sixth sample was produced by immersing the red pine chips made of raw wood in the ferrous chloride aqueous solution for 24 hours, thereafter drying the chips, and then carbonizing the chips at 900° C. The twenty-seventh sample was produced by immersing the dried red pine chips in the ferrous chloride aqueous solution for 24 hours, thereafter drying the chips, and then carbonizing the chips at 900° C. The twenty-eighth sample was produced by immersing the dried red pine chips in the ferrous sulfate aqueous solution for 24 hours, thereafter drying the chips, and then carbonizing the chips at 900° C. The twenty-ninth sample was produced by immersing the dried red pine chips in the ferric nitrate aqueous solution for 24 hours, thereafter drying the chips, and then carbonizing the chips at 900° C.

In the ferric chloride aqueous solution, the mass percent concentration of iron chloride hexahydrate is 20%. In the ferrous chloride aqueous solution, the mass percent concentration of iron chloride tetrahydrate (FeCl₂.4H₂O) is 20%. In the ferrous sulfate aqueous solution, the mass percent concentration of iron sulfide heptahydrate is 20%. In the ferric nitrate aqueous solution, the mass percent concentration of iron nitrate nonahydrate is 20%.

In the case where the maximum temperature is higher than 900° C., graphitization of the organic substance proceeds and the phosphorus adsorbent may be brittle. Further, as the maximum temperature becomes higher, the remaining amount of organic substance becomes less, a carbon collection ratio (yield) becomes lower, and the fuel cost increases. Therefore, the maximum temperature is preferably 900° C. or less.

As illustrated in FIG. 4, the ninth sample to twelfth sample, the fifteenth sample, the seventeenth sample to the twentieth sample, and the twenty-fourth sample to the twenty-seventh sample are preferable in that the phosphorus removal ratios of the test liquid are high. Namely, the phosphorus adsorbent is preferably produced by immersing the organic substance in the iron chloride aqueous solution, thereafter drying the chips, and then carbonizing the chips at 700° C. or higher.

As illustrated in FIG. 4, in the experiment of the sample using the dried red pine chips and the ferric chloride aqueous solution as the chemical solution, the phosphorus removal ratio of the test liquid was high in the case where the maximum temperature was 800° C. or more. Therefore, in the case where the dried wood and the ferric chloride aqueous solution as the chemical solution are used, the maximum temperature is preferably 800° C. or more. In the case where the maximum temperature was 900° C., the phosphorus removal ratio was further increased. Therefore, in the case where the dried wood and the ferric chloride aqueous solution as the chemical solution are used, the maximum temperature is preferably 900° C. or less.

As illustrated in FIG. 4, in the experiment of samples using the red pine chips made of raw wood and the ferric chloride aqueous solution as the chemical solution, the phosphorus removal ratios of the test liquid increased in the case where the maximum temperature was 700° C. or higher, whereas the phosphorus removal ratio of the test liquid relatively low in the case where the maximum temperature was 900° C. Therefore, in the case where the raw wood and the ferric chloride aqueous solution as the chemical solution were used, the maximum temperature is preferably 700° C. or more and 900° C. or less, more preferably 700° C. or more and 800° C. or less, and further preferably 700° C. or more and 750° C. or less. Setting the maximum temperature to 700° C. or more and 750° C. or less reduces the fuel cost, lowers the EC of the test liquid, and increases the phosphorus adsorption ratio.

As illustrated in FIG. 4, in the experiment of the sample using dried red pine chips and the ferrous chloride aqueous solution as the chemical solution, the phosphorus removal ratios of the test liquid increased in the case where the maximum temperature was 700° C. or more. Therefore, in the case where the dried wood and the ferrous chloride aqueous solution as the chemical solution were used, the maximum temperature is preferably 700° C. or more.

As illustrated in FIG. 4, in the experiment of samples using the red pine chips made of raw wood and the ferrous chloride aqueous solution as the chemical solution, the phosphorus removal ratios of the test liquid was high in the case where the maximum temperature was 700° C. or more, whereas the EC of the test liquid was high in the case where the maximum temperature was 700° C. In the case where the maximum temperature was 800° C., the EC of the test liquid was low. Therefore, in the case where the raw wood and the ferrous chloride aqueous solution as the chemical solution are used, the maximum temperature is preferably 800° C. or more. In the case where the maximum temperature was 900° C., the EC of the test liquid became lower. Therefore, in the case where the raw wood and the ferrous chloride aqueous solution as the chemical solution are used, the maximum temperature is more preferably 900° C. or less in that the graphitization of the organic substance can be reduced and the EC of a test liquid is low.

(Third Experiment)

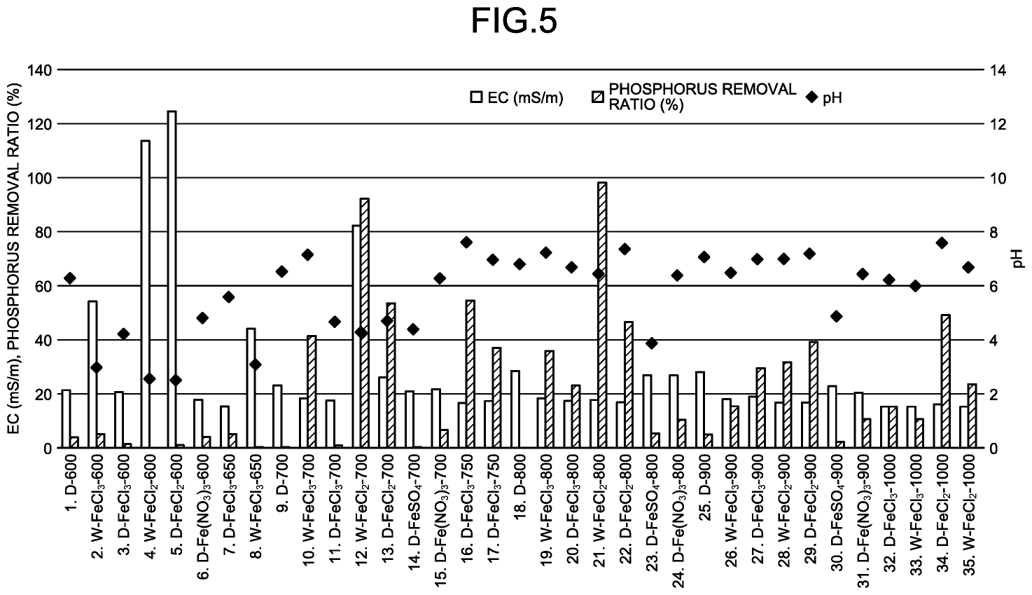

FIG. 5 is a graph illustrating the electrical conductivity, phosphorus removal ratio, and pH of the test liquid, in the case where the combination of materials, the solutes of the chemical solution in the immersion step, and temperatures at the carbonization step are changed. FIG. 5 illustrates the result of the third experiment. In the third experiment, the test container containing the phosphorus adsorbent and the test liquid was stirred by a shaker for 6 hours, and thereafter, the EC, the pH and the phosphorus removal ratio of the filtrate of the test liquid were measured.

The third experiment differs from the second experiment in that the concentration of phosphorus in the test liquid is 50 mg/l. The EC of the test liquid of the third experiment is 18.26 mS/m. The pH of the test liquid is 5.08. The first sample to the sixth sample of the third experiment are the same as the first sample to the sixth sample of the second experiment. The seventh sample of the third experiment was produced by immersing the red pine chips made of dried wood in the ferric chloride aqueous solution for 24 hours, thereafter drying the chips, and then carbonizing the chips at 650° C. The eighth sample to the fifteenth sample of the third experiment are the same as the seventh sample to the fourteenth of the second experiment. The sixteenth sample of the third experiment was produced by immersing the red pine chips made of dried wood in the ferric chloride aqueous solution for 24 hours, thereafter drying the chips, and then carbonizing the chips at 750° C. The seventeenth sample to the thirty-first sample of the third experiment are the same as the fifteenth sample to the twenty-ninth sample of the second experiment. The thirty-second sample of the third experiment was produced by immersing the red pine chips made of dried wood in the ferric chloride aqueous solution for 24 hours, thereafter drying the chips, and then carbonizing the chips at 1,000° C. The thirty-third sample of the third experiment was produced by immersing the red pine chips made of raw wood in the ferric chloride aqueous solution for 24 hours, thereafter drying the chips, and then carbonizing the chips at 1,000° C. The thirty-fourth sample of the third experiment was produced by immersing the red pine chips made of dried wood in the ferrous chloride aqueous solution for 24 hours, thereafter drying the chips, and then carbonizing the chips at 1,000° C. The thirty-fifth sample of the third experiment was produced by immersing the red pine chips made of raw wood in the ferrous chloride aqueous solution for 24 hours, thereafter drying the chips, and then carbonizing the chips at 1,000° C. In FIG. 5, the first sample to thirty-fifth sample are arranged from the left to the right of the horizontal axis.

The results of the third experiment indicate the almost same tendency as the results of the second experiment. Therefore, it is found that the production method described in the second experiment is similarly preferable even when the concentration of phosphorus is high.

As illustrated in FIG. 5, in the experiment of the sample using the dried red pine chips and the ferrous chloride aqueous solution as the chemical solution, the phosphorus removal ratio of the test liquid was high in the case where the maximum temperature was 1,000° C. Therefore, in the case where the dried wood and the ferrous chloride aqueous solution as the chemical solution are used, the maximum temperature may be 1,000° C. or more. In the case where the dried wood and the ferrous chloride aqueous solution as the chemical solution are used, the maximum temperature is preferably 700° C. or more and 1,000° C. or less.

(Fourth Experiment)

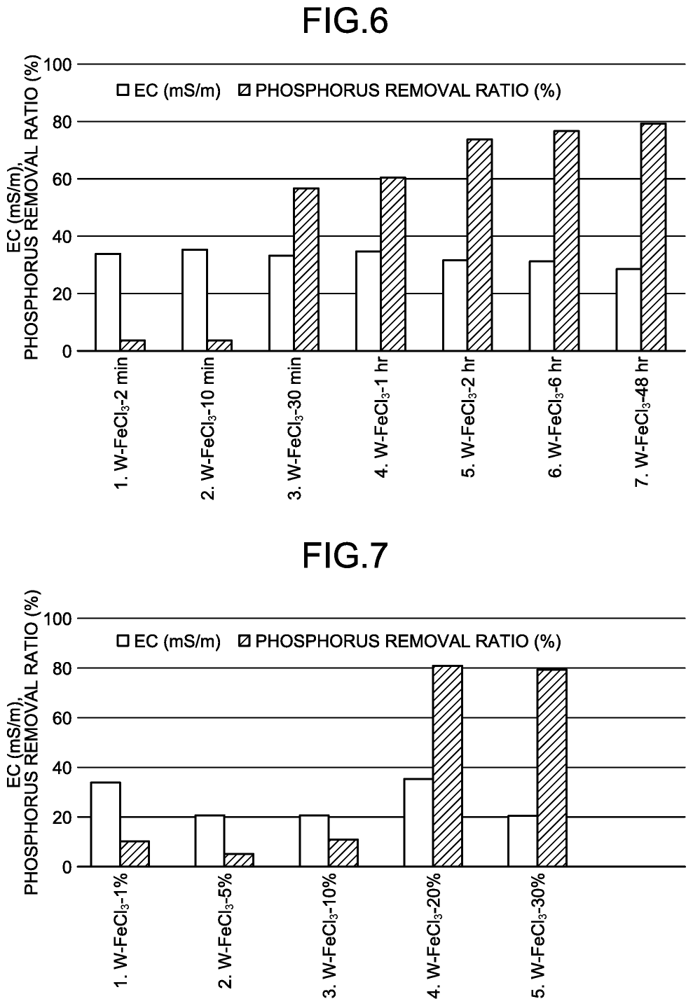

FIG. 6 is a graph illustrating the electrical conductivity and the phosphorus removal ratio of the test liquid in the case where immersion time at the immersion step is changed. FIG. 6 illustrates the result of the fourth experiment. In the fourth experiment, the test container containing the phosphorus adsorbent and the test liquid was stirred by a shaker for 6 hours, and thereafter the EC and the phosphorus removal ratio of the filtrate of the test liquid were measured.

The amount of each sample (phosphorus adsorbent) in the fourth experiment is 0.5 g. The test liquid is a potassium dihydrogen phosphate aqueous solution. The concentration of phosphorus in the test liquid is 100 mg/l. The amount of test liquid is 50 ml. The EC of the test liquid is 33 mS/m.

The sample (phosphorus adsorbent) in the fourth experiment was produced by immersing the red pine chips made of raw wood in the ferric chloride aqueous solution, thereafter drying the chips, and then carbonizing the chips at 700° C. In the ferric chloride aqueous solution, the mass percent concentration of iron chloride hexahydrate is 20%. In FIG. 6, the first sample to the seventh sample are arranged from the left to the right of the horizontal axis.

In the production process of the first sample in the fourth experiment, the red pine chips were immersed in the ferric chloride aqueous solution for 2 minutes. In the production process of the second sample, the red pine chips were immersed in the ferric chloride aqueous solution for 10 minutes. In the production process of the third sample, the red pine chips were immersed in the ferric chloride aqueous solution for 30 minutes. In the production process of the fourth sample, the red pine chips were immersed in the ferric chloride aqueous solution for 1 hour. In the production process of the fifth sample, the red pine chips were immersed in the ferric chloride aqueous solution for 2 hours. In the production process of the sixth sample, the red pine chips were immersed in the ferric chloride aqueous solution for 6 hours. In the production process of the seventh sample, the red pine chips were immersed in the ferric chloride aqueous solution for 48 hours.

As illustrated in FIG. 6, the third sample to seventh sample are preferable in that the phosphorus removal ratios of the test liquid are high. Namely, the phosphorus adsorbent is preferably produced by carbonizing the organic substance after the organic substance is immersed in the ferric chloride aqueous solution for 30 minutes or more. The phosphorus adsorbent is more preferably produced by carbonizing the organic substance after the organic substance is immersed in the ferric chloride aqueous solution for 1 hour or more. Furthermore, the phosphorus adsorbent is more preferably produced by carbonizing the organic substance after the organic substance is immersed in the ferric chloride aqueous solution for 2 hours or more.

(Fifth Experiment)

FIG. 7 is a graph illustrating changes in the electrical conductivity and the phosphorus removal ratio of the test liquid when the aqueous solution concentration at the immersion step is changed. FIG. 7 illustrates the result of the fifth experiment. In the fifth experiment, the test container containing the phosphorus adsorbent and the test liquid was stirred by a shaker for 6 hours, and thereafter the EC and the phosphorus removal ratio of the filtrate of the test liquid were measured.

The amount of each sample (phosphorus adsorbent) in the fifth experiment is 0.5 g. The test liquid is a potassium dihydrogen phosphate aqueous solution. The concentration of phosphorus in the test liquid is 100 mg/l. The amount of test liquid is 50 ml. The EC of the test liquid is 33 mS/m.

The material of the sample (phosphorus adsorbent) in the fifth experiment was produced by immersing the red pine chips made of raw wood in the ferric chloride aqueous solution for 24 hours, thereafter drying the chips, and then carbonizing the chips at 700° C. In FIG. 7, the first sample to the fifth sample are arranged from the left to the right of the horizontal axis.

In the ferric chloride aqueous solution used for the production of the first sample in the fifth experiment, the mass percent concentration of iron chloride hexahydrate is 1%. In the ferric chloride aqueous solution used for the production of the second sample in the fifth experiment, the mass percent concentration of iron chloride hexahydrate is 5%. In the ferric chloride aqueous solution used for the production of the third sample in the fifth experiment, the mass percent concentration of iron chloride hexahydrate is 10%. In the ferric chloride aqueous solution used for the production of the fourth sample in the fifth experiment, the mass percent concentration of iron chloride hexahydrate is 20%. In the ferric chloride aqueous solution used for the production of the fifth sample in the fifth experiment, the mass percent concentration of iron chloride hexahydrate is 30%.

As illustrated in FIG. 7, the fourth sample and the fifth sample are preferable in that the phosphorus removal ratios of the test liquid are high. Namely, in the ferric chloride aqueous solution used for the production of the phosphorus adsorbent, the mass percent concentration of iron chloride hexahydrate is preferably 20% or more. A mass percent concentration of iron chloride hexahydrate of 20% or more corresponds to a mass percent concentration of iron of 4% or more. Namely, in the chemical solution used for the production of the phosphorus adsorbent, the mass percent concentration of iron is preferably 4% or more.

(Sixth Experiment)

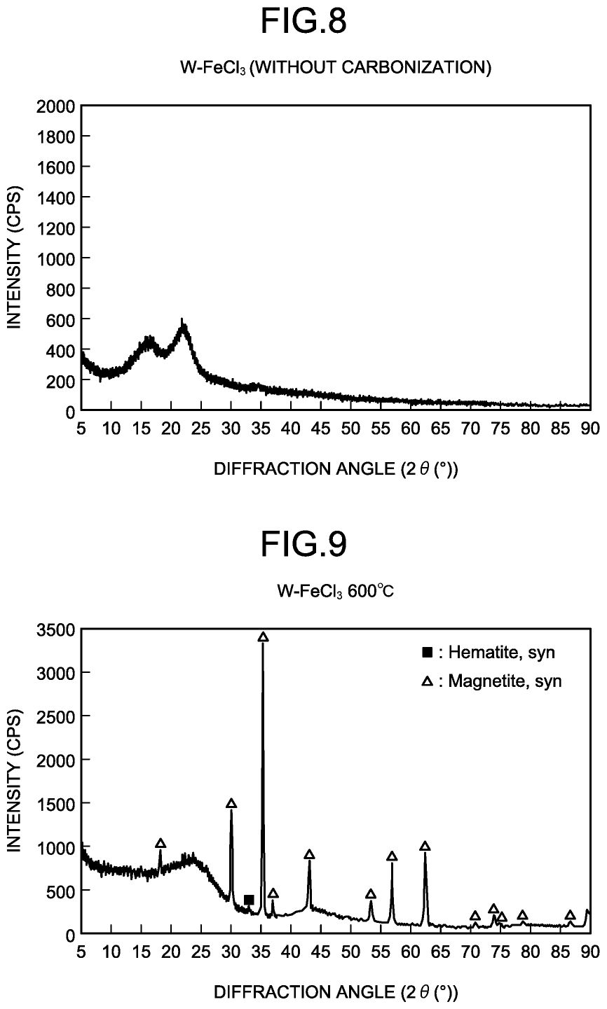

FIG. 8 to FIG. 20 illustrate the results of the sixth experiment. In the sixth experiment, measurement using an X-ray diffraction method was carried out for samples (phosphorus adsorbents). The X-ray diffraction method is a method of identifying atoms included in a sample by irradiating the sample with X-rays and measuring the reflected X-rays. The material of the sample of the sixth experiment is the red pine chips. As the sample in the sixth experiment, the dried red pine chips or the red pine chips made of raw wood were used.

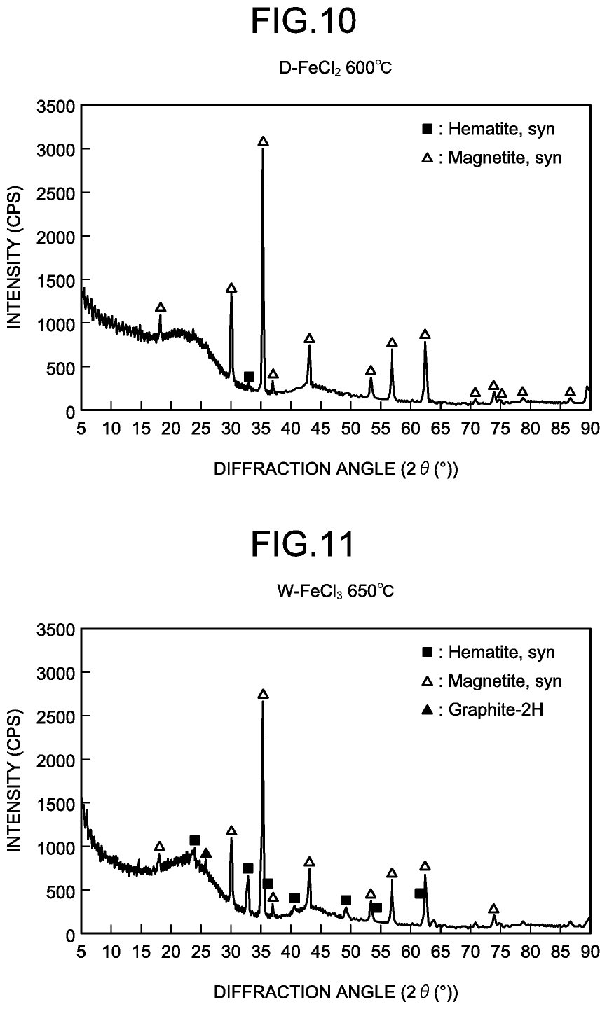

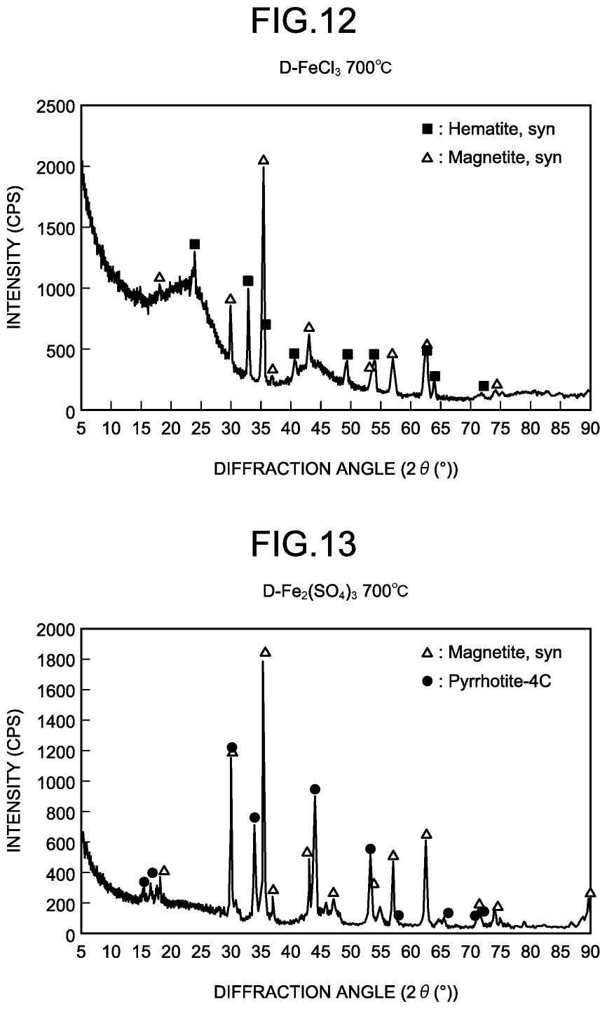

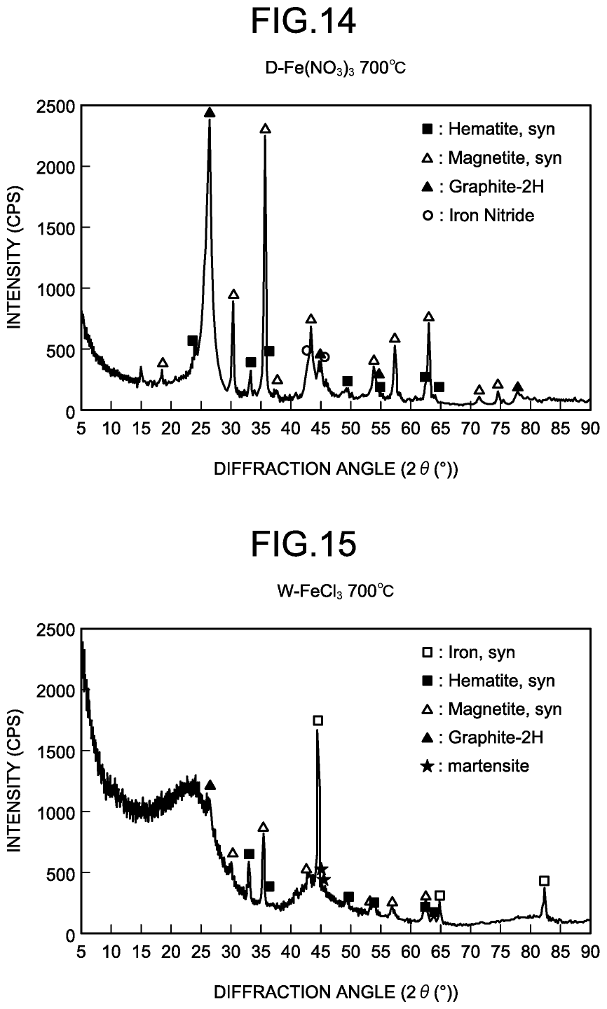

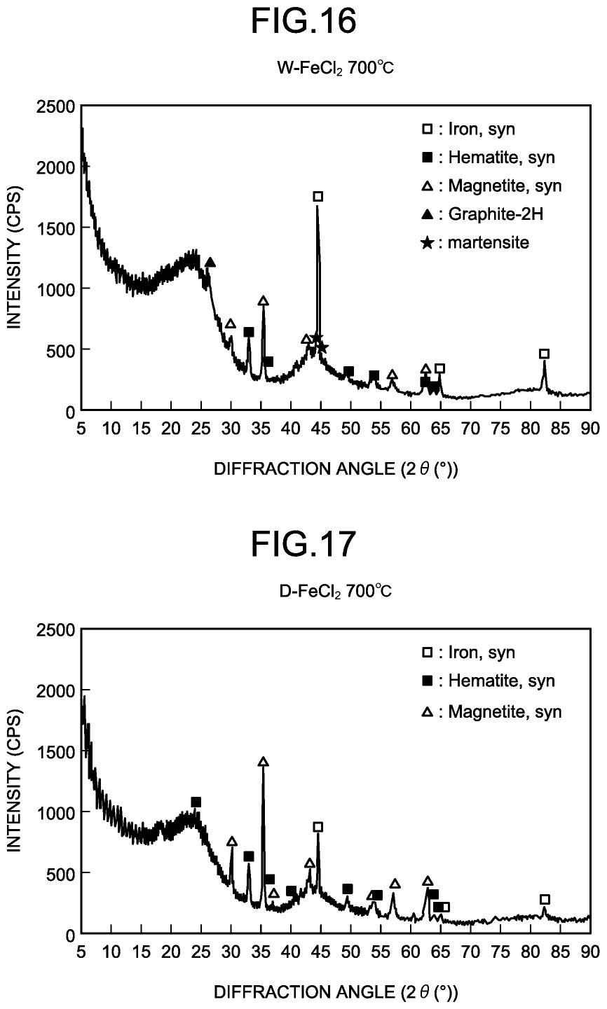

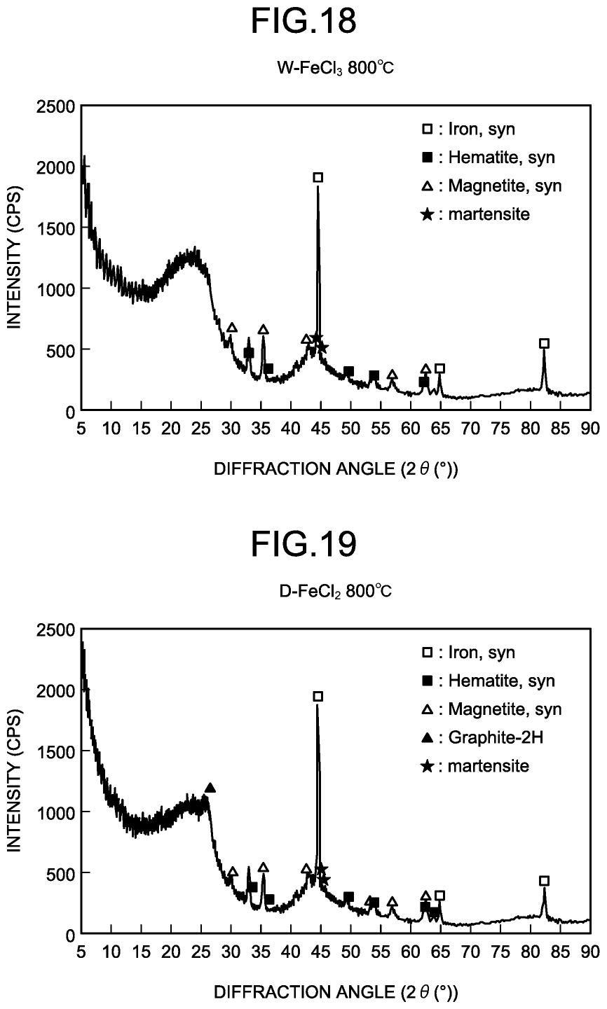

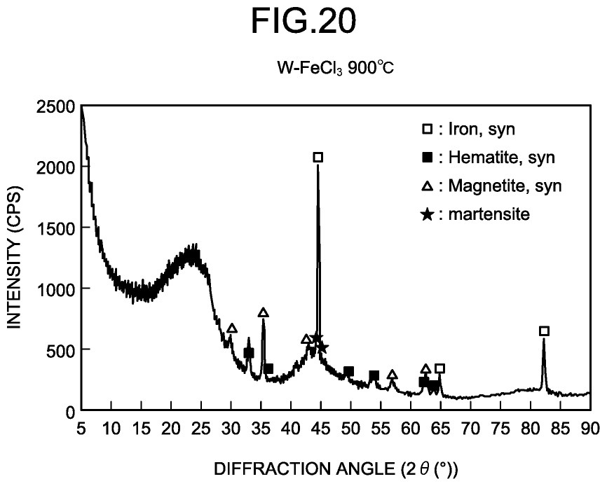

FIG. 8 is a graph illustrating the measurement results of the X-ray diffraction method with respect to the sample that is not carbonized after immersing raw wood in the ferric chloride aqueous solution. FIG. 9 is a graph illustrating the measurement results of the X-ray diffraction method with respect to a sample that is not carbonized at 600° C. after immersing raw wood in the ferric chloride aqueous solution. FIG. 10 is a graph illustrating the measurement results of the X-ray diffraction method with respect to a sample that is produced by immersing dried wood in the ferrous chloride aqueous solution and thereafter carbonizing the immersed wood at 600° C. FIG. 11 is a graph illustrating the measurement results of the X-ray diffraction method with respect to a sample that is produced by immersing raw wood in the ferric chloride aqueous solution and thereafter carbonizing the immersed wood at 650° C. FIG. 12 is a graph illustrating the measurement results of the X-ray diffraction method with respect to a sample that is produced by immersing dried wood in the ferric chloride aqueous solution and thereafter carbonizing the immersed wood at 700° C. FIG. 13 is a graph illustrating the measurement results of the X-ray diffraction method with respect to a sample that is produced by immersing dried wood in the polyferric sulfate (Fe₂(SO₄)₃) aqueous solution and thereafter carbonizing the immersed wood at 700° C. FIG. 14 is a graph illustrating the measurement results of the X-ray diffraction method with respect to a sample that is produced by immersing dried wood in the ferric nitrate aqueous solution and thereafter carbonizing the immersed wood at 700° C. FIG. 15 is a graph illustrating the measurement results of the X-ray diffraction method with respect to a sample that is produced by immersing raw wood in the ferric chloride aqueous solution and thereafter carbonizing the immersed wood at 700° C. FIG. 16 is a graph illustrating the measurement results of the X-ray diffraction method with respect to a sample that is produced by immersing raw wood in the ferrous chloride aqueous solution and thereafter carbonizing the immersed wood at 700° C. FIG. 17 is a graph illustrating the measurement results of the X-ray diffraction method with respect to a sample that is produced by immersing dried wood in the ferrous chloride aqueous solution and thereafter carbonizing the immersed wood at 700° C. FIG. 18 is a graph illustrating the measurement results of the X-ray diffraction method with respect to a sample that is produced by immersing raw wood in the ferric chloride aqueous solution and thereafter carbonizing the immersed wood at 800° C. FIG. 19 is a graph illustrating the measurement results of the X-ray diffraction method with respect to a sample that is produced by immersing dried wood in the ferrous chloride aqueous solution and thereafter carbonizing the immersed wood at 800° C. FIG. 20 is a graph illustrating the measurement results of the X-ray diffraction method with respect to a sample that is produced by immersing raw wood in the ferric chloride aqueous solution and thereafter carbonizing the immersed wood at 900° C.

As illustrated in FIG. 8, no peak is observed in the measurements result of the X-ray diffraction method with respect to the samples that are not carbonized. On the other hand, as illustrated in FIG. 9 to FIG. 11, peaks corresponding to at least hematite (Fe₂O₃) and magnetite (Fe₃O₄) are observed in the case where the iron chloride aqueous solution is used as the chemical solution and the immersed sample is carbonized at 650° C. or less, or in the case where the chemical solution that is not the iron chloride aqueous solution is used. As illustrated in FIG. 15 to FIG. 20, a peak corresponding to iron (Fe) is observed in the case where the iron chloride aqueous solution as the chemical solution is used and the immersed sample is carbonized at 700° C. or more. In the present disclosure, the peaks corresponding to iron are peaks corresponding to iron (Fe) as a metal and does not include a peak corresponding to the compound of iron (for example, iron chloride, iron nitrate, and iron oxide (such as magnetite or hematite)). The intensity of the maximum peak corresponding to iron is equal to or more than one-half of the intensity of the maximum peak corresponding to magnetite. In FIG. 15, FIG. 16, and FIG. 18 to FIG. 20, the intensity of the maximum peak corresponding to iron is equal to or higher than the intensity of the maximum peak corresponding to magnetite.

As described in the second experiment, the phosphorus removal ratio of the test liquid is high in the case where the iron chloride aqueous solution is used as the chemical solution and carbonization is carried out at 700° C. or more. The phosphorus adsorbents (samples corresponding to FIG. 15 to FIG. 20) having the peaks corresponding to iron can adsorb more phosphorus.

As described above, the phosphorus adsorbent 1 of the embodiment includes the carrier 2 that is a carbonized organic substance and the iron 3 supported on the carrier 2.

The phosphorus adsorbents 1 can adsorb phosphorus by including iron 3. The phosphorus adsorbent 1 can be produced without using a material including silicon as described in JP-A-2007-75706. The material for the phosphorus adsorbent 1 is less likely to be limited. Thus, the phosphorus adsorbent 1 can be produced from various materials.

Further, in the phosphorus adsorbent 1, there are the peaks corresponding to iron in the measurement result of the X-ray diffraction method. This increases the amount of phosphorus absorbed by the phosphorus adsorbent 1. The phosphorus adsorbent 1 can improve the phosphorus removal efficiency.

In the phosphorus adsorbent 1, the intensity of the maximum peak corresponding to iron is equal to or more than one-half of the intensity of the maximum peak corresponding to magnetite in the measurement result of the X-ray diffraction method. This increases the amount of phosphorus absorbed by the phosphorus adsorbent 1. The phosphorus adsorbent 1 can improve the phosphorus removal efficiency.

In the phosphorus adsorbent 1, the carrier 2 is porous. Part of iron 3 is located at the inside of the carrier 2. This increases the amount of iron included in the phosphorus adsorbent 1 per unit volume. Therefore, the amount of phosphorus absorbed by the phosphorus adsorbent 1 increases. The phosphorus adsorbent 1 can improve the phosphorus removal efficiency.

The method of producing the phosphorus adsorbent 1 includes the immersion step S1 of immersing the organic substance in the chemical solution containing iron ions and the carbonization step S3 of carbonizing the organic substance after the immersion step S1.

The carbonization step S3 is carried out after the immersion step S1, and thus the metal is less likely to be eluted from the phosphorus adsorbent 1 in the case where the phosphorus adsorbent 1 is added into water including phosphorus. Thus, the phosphorus adsorbent 1 can retain the adsorbed phosphorus. In the method of producing the phosphorus adsorbent 1, the material including silicon as described in JP-A-2007-75706 is not necessarily used. According to the method of producing the phosphorus adsorbent 1, the material is less likely to be limited. Thus, the method of producing the phosphorus adsorbent 1 can produce the phosphorus adsorbent 1 from various materials.

In the method of producing the phosphorus adsorbent 1, the chemical solution is preferably the iron chloride aqueous solution and the maximum temperature of the organic substance at the carbonization step S3 is preferably 700° C. or more. This improves the phosphorus removal efficiency by the phosphorus adsorbent 1.

In the method of producing the phosphorus adsorbent 1, the maximum temperature of the organic substance at the carbonization step S3 is preferably 900° C. or less. This makes the organic substance less likely to graphitize and thus reduces embrittlement of the phosphorus adsorbent 1. Further, the remaining amount of the organic substance increases, thereby improving the carbon collection ratio (yield), as well as reducing the fuel cost.

In the method of producing the phosphorus adsorbent 1, the mass percent concentration of iron in the chemical solution is preferably 4% or more. This improves the phosphorus removal efficiency by the phosphorus adsorbent 1.

In the method of producing the phosphorus adsorbent 1, the time for immersing the organic substance in the chemical solution at the immersion step S1 is preferably 30 minutes or more. This improves the phosphorus removal efficiency by the phosphorus adsorbent 1.

In the method of producing the phosphorus adsorbent 1, the organic substance is wood. This makes the phosphorus adsorbent 1 porous and thus increases the amount of phosphorus absorbed by the phosphorus adsorbent 1. Therefore, the phosphorus removal efficiency by the phosphorus adsorbent 1 can be improved.

In the method of producing the phosphorus adsorbent 1, it is preferable that the chemical solution be the ferric chloride aqueous solution, the organic substance be the dried wood, and the maximum temperature of the organic substance at the carbonization step S3 be 800° C. or more. This improves the phosphorus removal efficiency by the phosphorus adsorbent 1.

In the method of producing the phosphorus adsorbent 1, it is preferable that the chemical solution be the ferric chloride aqueous solution, the organic substance be the raw wood, and the maximum temperature of the organic substance at the carbonization step S3 be 700° C. or more and 900° C. or less. This improves the phosphorus removal efficiency by the phosphorus adsorbent 1. Further, the maximum temperature of the organic substance at the carbonization step S3 is preferably 750° C. or less. This makes the metal less likely to be eluted from the phosphorus adsorbent 1 in the case where the phosphorus adsorbent 1 is added into water including phosphorus.

In the method of producing the phosphorus adsorbent 1, it is preferable that the chemical solution be the ferrous chloride aqueous solution, the organic substance be the dried wood, and the maximum temperature of the organic substance at the carbonization step S3 be 700° C. or more. This improves the phosphorus removal efficiency by the phosphorus adsorbent 1.

In the method of producing the phosphorus adsorbent 1, it is preferable that the chemical solution be the ferrous chloride aqueous solution, the organic substance be the raw wood, and the maximum temperature of the organic substance at the carbonization step S3 be 800° C. or more. This improves the phosphorus removal efficiency by the phosphorus adsorbent 1 and makes the metal less likely to be eluted from the phosphorus adsorbent 1. Further, the maximum temperature of the organic substance at the carbonization step S3 is preferably 900° C. or less. This reduces the graphitization of the organic substance and makes the metal less likely to be eluted from the phosphorus adsorbent 1.

What is claimed is:

1. A phosphorus adsorbent comprising:
a carrier that is a carbonized organic substance; and
iron supported on the carrier, wherein
peaks corresponding to iron are present in a measurement result of an X-ray diffraction method, and
intensity of a maximum peak corresponding to iron is equal to or more than one-half of intensity of a maximum peak corresponding to magnetite in the measurement result of the X-ray diffraction method.

2. The phosphorus adsorbent according to claim 1, wherein a peak corresponding to Graphite-2H is present in the measurement result of the X-ray diffraction method.

3. The phosphorus adsorbent according to claim 1, wherein the carrier is porous, and
part of the iron is located inside the carrier.

4. The phosphorus adsorbent according to claim 2, wherein the carrier is porous, and
part of the iron is located inside the carrier.

5. A method of producing a phosphorus adsorbent, the method comprising:
immersing an organic substance in a chemical solution containing iron ions; and
carbonizing the organic substance after the immersion.

6. The method of producing a phosphorus adsorbent according to claim 5, wherein
the chemical solution is an iron chloride aqueous solution, and
a maximum temperature of the organic substance at the carbonization is 700° C. or more.

7. The method of producing a phosphorus adsorbent according to claim 6, wherein the maximum temperature of the organic substance at the carbonization is 900° C. or less.

8. The method of producing a phosphorus adsorbent according to claim 6, wherein a mass percent concentration of iron in the chemical solution is 4% or more.

9. The method of producing a phosphorus adsorbent according to claim 7, wherein a mass percent concentration of iron in the chemical solution is 4% or more.

10. The method of producing a phosphorus adsorbent according to claim 6, wherein at the immersion, time for immersing the organic substance in the chemical solution is 30 minutes or more.

11. The method of producing a phosphorus adsorbent according to claim 5, wherein the organic substance is wood.

12. The method of producing a phosphorus adsorbent according to claim 5, wherein
the chemical solution is a ferric chloride aqueous solution,
the organic substance is dried wood, and
a maximum temperature of the organic substance at the carbonization is 800° C. or more.

13. The method of producing a phosphorus adsorbent according to claim 5, wherein
the chemical solution is a ferric chloride aqueous solution,
the organic substance is raw wood, and
a maximum temperature of the organic substance at the carbonization is 700° C. or more and 900° C. or less.

14. The method of producing a phosphorus adsorbent according to claim 13, wherein the maximum temperature of the organic substance at the carbonization is 750° C. or less.

15. The method of producing a phosphorus adsorbent according to claim 5, wherein
the chemical solution is a ferrous chloride aqueous solution,
the organic substance is dried wood, and
a maximum temperature of the organic substance at the carbonization is 700° C. or more.

16. The method of producing a phosphorus adsorbent according to claim 5, wherein
the chemical solution is a ferrous chloride aqueous solution,
the organic substance is raw wood, and
a maximum temperature of the organic substance at the carbonization is 800° C. or more.

17. The method of producing a phosphorus adsorbent according to claim 16, wherein the maximum temperature of the organic substance at the carbonization is 900° C. or less.
